(19) United States
(12) Patent Application Publication
(10) Pub. No.: US 2026/0052035 A1
(43) Pub. Date: Feb. 19, 2026

(54) GATEWAY FOR A FIELDBUS SYSTEM

(71) Applicant: Murrelektronik GmbH, Oppenweiler (DE)

(72) Inventors: Ingo WOLFF, Oppenweiler (DE); Wolfgang WIEDEMANN, Oppenweiler (DE)

(21) Appl. No.: 19/298,278

(22) Filed: Aug. 13, 2025

(30) Foreign Application Priority Data
Aug. 13, 2024 (EP) 24 194 331.5

(51) Int. Cl. H04L 12/40; H04L 12/66

(52) U.S. Cl. CPC H04L 12/40; H04L 12/66; H04L 2012/40221

(57) ABSTRACT

A gateway for a fieldbus system for connecting a controller to an industrial plant having a plurality of different components. The gateway includes at least one component interface via which the different components can be connected simultaneously or sequentially, a control interface to which a controller of the industrial plant can be connected, and a data processing module which, when at least one of the components is connected to the at least one component interface, is configured to identify the at least one component on the basis of a hardware address assigned thereto and to communicate with the at least one component via the component interface, and which, when the controller is connected to the control interface, is configured to communicate with the controller and to represent the at least one component with respect to the controller as a function-based representation. Furthermore, a fieldbus system is described.

### FIELD OF THE DISCLOSURE

Embodiments of the present disclosure relate to a gateway for a fieldbus system for connecting a controller to an industrial plant. Furthermore, embodiments of the present disclosure relate to a fieldbus system.

### BACKGROUND

So far, machines or industrial plants are usually built up as monolithic construct. This means that the machine or industrial plant is first planned in its entirety and then constructed.

However, the concept of modular industrial plants also becomes increasingly established. Here, several modules, for example individual assemblies or entire machines, are connected so as to form a plant. Here, the individual modules are typically also monolithic in design.

Generally, a machine or industrial plant has a controller which controls a field level. Today, the field level in most cases consists of a field bus, IO modules, sensors and actuators. Traditionally, plans and parts lists are created for each individual component. All components are then represented, named, and also parameterized in the controller using a hardware configuration. This enables the controller to address various endpoints, in particular sensors or actuators, of the machine or industrial plant.

The conventional working method assumes that all endpoints are present. If an endpoint is missing or does not correspond to the description in the hardware configuration, it can be assumed that there is an error. This assumption is used to prevent erratic behavior or to detect errors. Controllers and fieldbus systems, in particular ProfiNet, Ethernet IP, Powerlink, CC link IE, and Ethercat, first check whether the configuration matches the actual hardware status. This is then used to decide, for example, whether a machine or industrial plant can be put into operation.

Traditionally, it is not provided that machine parts or industrial plant parts are present in a modified form. At most, it is known that a virtual version of the industrial plant is stored in the controller in an oversized form, for example with 120% of the provided components, wherein individual components can be hidden to then find the actually present industrial plant.

However, with increasing technological progress, adaptability to rapidly changing production requirements becomes increasingly important, which can no longer be achieved by hiding components. Series-connected machines are therefore often configured as modular systems today. Here, certain components are optional or present in different equipment options. The hardware configuration must then be adapted for each machine. If necessary, programs must also be adapted to the configuration.

It is also possible to use individual components, such as sensors and actuators, which differ in their hardware but have the same functions and/or properties. Components from different manufacturers are particularly noteworthy here. These are often incompatible because they have data interfaces which differ minimally. The use of a component from another manufacturer therefore in most cases involves complex program changes and/or software adjustments to the controller. When replacing a component with another component which offers the same functions but has a different interface, the effort involved in reprogramming is often not justified. However, if a specific defective component is no longer available, plant downtime occurs until the hardware configuration and any existing software programs have been adapted. It would therefore be desirable to be able to use different sensors or actuators for the same function and to be able to replace them easily.

Further challenges can arise when different components of a machine and/or industrial plant operate with different fieldbuses. This occurs, for example, during technology conversions or further developments and/or in so-called brownfield plants, i.e., industrial plants which have already been built and have been in operation for a long time and into which new or further developed functions are integrated, such as an IoT connection (Internet of Things), i.e., a connection to a global information infrastructure.

This makes it necessary to create interfaces between the fieldbuses. For this purpose, information must be reassigned. It may also be necessary to completely or partially replace hardware components, for example, conventional sensors and/or actuators, with modern IO-Link or SPE (Single Pair Ethernet) variants.

Accordingly, there is a need to solve the problems described above in the systems known from the prior art in a technically simple manner.

### SUMMARY

Embodiments of the present disclosure provide a gateway for a fieldbus system for connecting a controller to an industrial plant having a plurality of different components. The gateway comprises at least one component interface via which the different components can be connected simultaneously or sequentially, a control interface to which a controller of the industrial plant can be connected, and a data processing module. The data processing module, when at least one of the components is connected to the at least one component interface, is configured to identify the at least one component on the basis of a hardware address assigned thereto and to communicate with the at least one component via the component interface. Furthermore, the data processing module, when the controller is connected to the control interface, is configured to communicate with the controller and to represent the at least one component with respect to the controller as a function-based representation.

The at least one component interface may comprise a hardware interface, for example a connection for a cable, and/or a software interface through which a data connection can be established between the connectable components and the gateway.

The data processing module may be configured as a hardware component and/or as a software component.

The controller is, for example, a programmable logic controller (PLC).

The basic idea is to use function-based representations of components instead of the usual structurally oriented representation to control industrial plants and to provide a suitable interface for this purpose. Therefore, individual components and the topological positions thereof are no longer represented with respect to the controller, but rather the functions thereof. In terms of function, it is therefore possible to refer to the properties and/or parameters of the respective component. In other words, the controller sees virtual addresses of functions, which corresponds to the function-based representations. The gateway then assigns the virtual addresses of functions, i.e., the function-based representations, to the components, in particular to the hardware addresses.

The function-based representations can in particular map the sensors and/or actuators of a mechatronic unit, for example a conveyor unit, a material feed, a robot arm, or any other component of the industrial plant.

In other words, the function-based representations represent hardware abstractions of the respective components, in particular with regard to the function thereof.

The focus here is primarily on the functions of the components. The gateway thus forms a function interface between the controller and the represented components.

On the basis of the function-based representations, it is possible to represent data points or entities, such as “start,” “stop,” “material available,” “door closed,” or similar. Which sensor or actuator of a component, for example a conveyor unit, is or must be addressed is irrelevant for the controller. Preferably, always the same function-based representations are mapped with respect to the controller.

Individual sensors or actuators may also be components and can be represented as function-based representations. This has the advantage that components from different manufacturers which serve the same purpose or have the same function can be easily exchanged and connected to the controller. Figuratively speaking, a level sensor from a specific manufacturer can be installed in the industrial plant and represented with respect to the controller as a function-based representation. The function-based representation may, for example, be limited to reproduce a level indication in an abstract manner as a percentage with respect to the controller. If the level sensor is now replaced by a different level sensor from another manufacturer, the gateway still represents the same function-based representation with respect to the controller. The sensors are therefore easily interchangeable without having to intervene in the controller.

Communication between a component connected to the component interface and the gateway, in particular the data processing module, is for example bidirectional. However, unidirectional communication is also generally possible. In other words, a signal, for example a control signal, can thus be sent from the controller to the component via the gateway (unidirectional) and, optionally, a response signal can be received (bidirectional). It is also conceivable that only a sensor signal or a comparable data signal from a component is received by the gateway or the controller (unidirectional).

Preferably, the data processing module is configured to always represent all components which can be connected to the at least one component interface with respect to the controller as function-based representations, in particular regardless of whether the respective components are actually connected to the component interface. The gateway can thus always represent a complete function-based representation of all connectable components with respect to the controller, even if one or more components are not connected to the gateway, in particular to the at least one component interface. In other words, the connection of individual components to the industrial plant or the gateway is optional, which is why the components individually or units of several components, hereinafter also referred to as assemblies, can be regarded as options of the industrial plant.

A particularly fault-tolerant drive can be implemented due to the always complete function-based representation of the connectable components.

The gateway can basically be configured as an independent hardware device, in particular for arrangement in the fieldbus system between the controller and at least one of the components. This makes it independent of other devices and therefore relatively easy to install, replace, and/or maintain.

Alternatively, the gateway may also be configured as a part of a hardware device of the industrial plant, in particular of a fieldbus module or a switch, which saves hardware.

In a further variant, the gateway may be configured as a part of an edge gateway. In this context, it is conceivable that the gateway is configured to connect or transfer the function-based representations of the components directly to a cloud.

The gateway may also be based on container visualization software, in particular on the Docker software.

It is furthermore conceivable that the gateway is configured as a software module which can in particular be implemented in a control device which comprises the controller. Generally, hardware can also be saved in this configuration. In addition, the controller and the gateway can thus communicate directly with each other, in particular without having to provide data lines for this purpose.

In principle, the gateway may also be configured as a decentralized device comprising a plurality of gateway submodules, each of the gateway submodules being configured to be connected, in particular directly, to a respective one of the components.

If, for example, a further component or option is to be connected to the industrial plant or the controller, it can be easily connected to one end of the fieldbus via the corresponding gateway submodule. For this purpose, the gateway submodule can for example be configured as an adapter which can be connected directly to the component, for example via a plug connection and/or screw connection. This is technically easy to implement. The respective gateway submodule can then transfer the function-based representation of the component to the controller via the fieldbus.

In a further variant, the data processing module is configured to communicate sequentially or simultaneously with more than one of the components and to represent the several components with respect to the controller as a single function-based representation. For example, the industrial plant may have a conveyor unit for feeding material, which in turn comprises a plurality of sensors and/or actuators. The conveyor unit can be mapped with respect to the controller as a single function-based representation or as an option. In simple terms, data points or entities such as “start,” “stop,” “material available,” etc. of the conveyor unit are represented with respect to the controller instead of the individual sensors and/or actuators. Which individual sensor or actuator is addressed is irrelevant for the controller, because always the same function-based representation is mapped with respect thereto. In simple terms, the data processing unit can thus bundle information from several components and represent the components in a function-based manner as a unit with respect to the controller.

It is also conceivable that the gateway comprises an assignment table which assigns at least one function-based representation to each of the components. The assignment table can comprise a plurality of function-based representations, in particular wherein each of the function-based representations has at least one of the components assigned thereto. The assignment table creates an error-resistant link between the components and the function-based representations in a technically simple manner. New components and/or components from other manufacturers can be integrated into the industrial plant relatively easily by adapting and/or expanding the assignment table. No intervention in the controller itself is necessary.

For illustration purposes, an example of an assignment table for a material conveyor in an industrial plant is shown below.

| Function-based | Option 1: | Option 2: |
|---|---|---|
| representations | conveyor unit small | conveyor unit large |
| On | Conveyor_1.Motor_1.on( ) | Conveyor_1.Motor_1.on( ) |
| | | Conveyor_1.Motor_2.on( ) |
| Off | Conveyor_1.Motor_1.off( ) | Conveyor_1.Motor_1.off( ) |
| | | Conveyor_1.Motor_2.off( ) |
| Material available | Conveyor_1.Sensor_1.( ) | Conveyor_1.Sensor_1.( ) |
| | | Conveyor_1.Sensor_2.( ) |

The assignment table shown creates an assignment of several different assemblies or options, for example different conveyor units, and corresponding function-based representations.

The function-based representations describe entities of the assigned assemblies, for example the states “on,” “off,” “material available,” etc.

The assignment table can also include information about which components (e.g., motor 1, motor 2, sensor 1, sensor 2, etc.) of the respective assembly are driven or are to be driven in which states.

Preferably, only the function-based representations, i.e., the entities listed in the first column of the assignment table shown, are represented with respect to the controller. In simple terms, it is therefore irrelevant for the controller which of the assemblies (option 1 or option 2) is actually present in the industrial plant and which components the connected assembly comprises. This also makes it easy to replace the small conveyor unit according to option 1 with the larger conveyor unit according to option 2. The options or assemblies represented in the assignment table can namely simply be exchanged without having to intervene in the controller.

Alternatively, it is also possible that the gateway is configured to access an external assignment table which can be stored in cloud storage, for example, to realize an assignment between the components and the function-based representations.

As already explained above, the controller only drives the function-based representations, which corresponds to virtual addresses of functions provided by at least one of the components. Using the assignment table, the gateway then assigns the virtual address of the corresponding function driven by the controller, i.e., the driven function-based representation, to the at least one component, in particular the respective hardware address.

Basically, it is therefore possible for components to be exchanged or replaced in a simple manner and that this does not result in any changes to the complex controller, since the controller only drives the function-based representations, i.e., virtual addresses of functions.

Furthermore, it may be provided that the gateway comprises program code, in particular glue code, which maps a relationship between first data of a first component of the components and second data of a function-based representation assigned to the first component, so that the first data and the second data can be converted into each other. Figuratively speaking, a sensor signal, for example, which indicates the filling level of a reservoir in an industrial plant, can be converted into a volume, a percentage, or the information “material available” by means of the program code. This also simplifies the replacement of components and/or entire assemblies.

The glue code can also be used to generate and manipulate arbitrary data points so that an expected function-based representation can be created and represented with respect to the controller. For example, the glue code can be used to generate a status or entity of an assembly from recorded states of the individual components.

Alternatively or additionally, the use of a glue code is also conceivable to convert the data of different components into each other, for example to convert a first sensor signal of a first option into a second sensor signal of a second option. The second sensor signal can then in turn be assigned to a function-based representation using an assignment table.

The gateway, in particular a processor of the gateway, can be set up to execute the program code, i.e., the glue code.

In a further variant, the gateway comprises a hardware configurator through which component configurations for configuring the components can be set, in particular manually by a user.

For example, the gateway is configured to configure and/or parameterize components connected to the component interface. In other words, the components can thus be configured directly using the gateway. Separate configuration by the controller is therefore not necessary, which in turn simplifies the controller as a whole. Therefore, less complex control programs can be used for control.

It is furthermore conceivable that the data processing module is configured to check whether one or more of the components which are expected to be connected to the component interface are actually connected to the component interface, for example by means of a cyclic redundancy check. This measure can increase the functional safety of the industrial plant.

The gateway can also be configured to take further specific safety precautions for protection against malfunctions of the industrial plant and/or for minimizing the impact of malfunctions.

In particular, measures in accordance with the EN ISO 13849 and/or IEC 61508 standards can be applied.

In simple terms, the gateway, in particular the data processing module, can be used to check the correctness and/or completeness of the connected components. This allows safety measures to be implemented without having to intervene in the controller.

In particular, the gateway may also be configured to check whether, how many, and/or which components are connected to the component interface based on an expected value specified by the controller. This information can then be optionally reported back to the controller.

The gateway may also be configured to receive a correction value, in particular from the controller. The correction value can, for example, be included in the context of a cyclic redundancy check by the gateway when determining a test value to determine whether the plant is ready for operation.

Furthermore disclosed is a fieldbus system for an industrial plant, comprising a gateway according to the present disclosure and a controller connected to the gateway via the control interface. The advantages discussed for the gateway apply equally to the fieldbus system.

In one variant, the controller of the fieldbus system is configured to access function-based representations provided by the gateway of components which can be connected to the industrial plant.

In other words, the controller is configured to address individual components not on the basis of the topological position thereof in the industrial plant, but on the basis of the functions, properties, and/or parameters thereof.

In particular, a function-based representation may correspond to a virtual address of individual components and/or a unit of several components.

A single component can therefore be addressed by the controller on the basis of its respective function-based representation. Similarly, several components forming a unit can be addressed by the controller on the basis of the function-based representation assigned thereto.

In a further embodiment, the controller is configured to drive function-based representations provided by the gateway. The gateway is designed to forward the drives from the controller to the components, taking an assignment table into account to which the gateway has at least access.

Therefore, the controller does not drive the components directly, but in an abstracted manner via the gateway. In simple terms, a hardware abstraction of the components takes place, which in turn simplifies the controller as a whole and leads to better interchangeability of components and easier integration of new components.

The assignment table may be stored in the gateway itself. Alternatively, the assignment table may also be stored externally at a location that the gateway can access.

It may also be provided that the fieldbus system comprises a function configurator through which individual function-based representations can be configured.

This allows the function-based representations to be adapted in accordance with the specific requirements of the industrial plant, for example by a user.

For example, individual options and/or function-based representations can be purposefully activated or deactivated using the function configurator. The operations management of the industrial plant can thus be adapted with minimal effort to hardware changes.

Basically, the gateway may be arranged within the fieldbus system as an independent hardware device or as a part of another hardware device between the controller and the components. It is also conceivable to design it as a decentralized device and/or software module.

It is also possible to distribute the discussed gateway functions across several devices of the industrial plant.

It may also be provided that the fieldbus system comprises a plurality of gateways according to the disclosure, which are in particular arranged in a cascaded manner to be able to implement more complex control tasks.

### BRIEF DESCRIPTION OF THE DRAWINGS

Further features and advantages will become apparent from the description below and from the drawings to which reference is made and in which:

FIG. 1 shows a schematic representation of an industrial plant with a fieldbus system known from the prior art;

FIG. 2 shows a schematic representation of an industrial plant and a fieldbus system according to a first embodiment of the present disclosure for controlling the industrial plant;

FIG. 3 shows a schematic representation of an industrial plant and a fieldbus system according to a second embodiment of the present disclosure for controlling the industrial plant;

FIG. 4 shows a schematic representation of a third embodiment of a fieldbus system according to the present disclosure with several different connectable components; and

FIG. 5 shows a schematic representation of a gateway designed as a decentralized device.

### DETAILED DESCRIPTION OF THE DRAWINGS

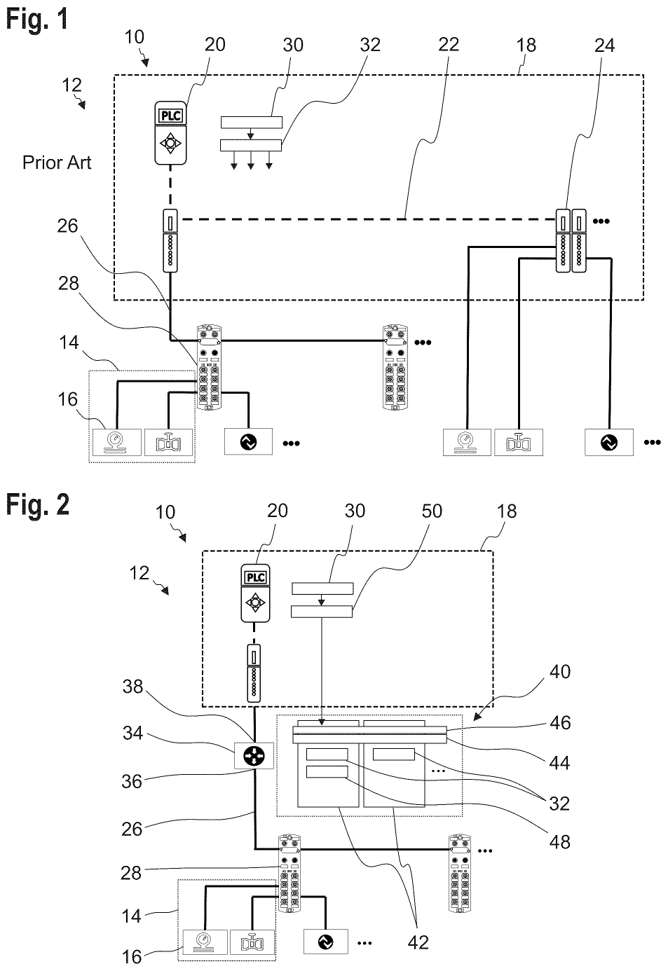

FIG. 1 shows a schematic representation of an industrial plant 10, for example a production plant for producing goods, and a fieldbus system 12 known from the prior art for the control thereof.

The industrial plant 10 has a modular design and comprises a plurality of assemblies 14, e.g. conveyor units for feeding material, industrial robots and/or processing stations.

The industrial plant 10 can be expanded by adding further assemblies 14. However, it is also possible to remove or shut down individual assemblies 14 and/or to replace them with other assemblies 14. The respective assemblies 14 are therefore optional and are thus also referred to as “options” in the following.

The assemblies 14 in turn each comprise one or more components 16, such as sensors and/or actuators, for detecting various parameters and/or for driving various functions. The components 16 within an assembly 14 may also be replaceable. For example, a sensor of a certain type and/or manufacturer may be replaced by another sensor of a different type and/or manufacturer.

It is also conceivable that further components 16 can be added to an assembly 14 and/or components 16 can be removed from an assembly 14. In simple terms, the components 16 are also optional. These are also “options.”

An assembly 14 can also comprise a single component 16 or be formed from a single component 16. In this case, the terms component 16 and assembly 14 can therefore refer to the same physical object.

The fieldbus system 12 shown in FIG. 1 includes a controller 18 having a control arithmetic unit 20, controller-internal bus connections 22, and a plurality of IO modules 24. A fieldbus 26 having a plurality of fieldbus modules 28 is connected to the controller 18. In turn, individual or several of the sensors and/or actuators (i.e., components 16) are respectively connected to the fieldbus modules 28.

The control unit 18 comprises a control program 30 and a hardware configurator 32 for configuring the individual components 16 connected via the fieldbus 26. For driving purposes, a direct access or routing to the respective components 16 is carried out by the controller 18 based on the respective hardware addresses thereof.

If one of the components 16 or an entire assembly 14 is replaced, shut down, or a new component 16 or a new assembly 14 is added, complex interventions in the controller 18 are necessary to adapt it to the changed hardware situation and to maintain uninterrupted plant operation.

FIG. 2 shows a schematic representation of an industrial plant 10 and a fieldbus system 12 according to a first embodiment for controlling the industrial plant 10. The industrial plant 10 and the fieldbus system 12 have a plurality of elements that correspond to the industrial plant 10 shown in FIG. 1 and the fieldbus system 12 shown in FIG. 1. Identical or functionally identical components are provided with the same reference numerals.

In contrast to the conventional fieldbus system 12 shown in FIG. 1, the fieldbus system 12 shown in FIG. 2 has a gateway 34 according to the present disclosure connected to the controller 18.

The gateway 34 has at least one component interface 36 via which the different components 16 and/or entire assemblies 14 of the industrial plant 10 are directly or indirectly connected to the gateway 34 simultaneously or sequentially, for example via further fieldbus modules 28.

Furthermore, the gateway 34 has a control interface 38 to which the controller 18 of the industrial plant 10 is connected.

In the variant shown in FIG. 2, the gateway 34 is configured as an independent hardware device and is arranged in the fieldbus system 12 between the controller 18 and the components 16 or assemblies 14. This is of course not to be understood in a restrictive way. Alternatively, the gateway 34 can also be configured as part of another hardware device of the industrial plant 10, in particular of a fieldbus module 28 or a switch.

The gateway 34 comprises a data processing module 40 which is configured to identify the components 16 or assemblies 14 connected to the component interface 36 on the basis of hardware addresses assigned thereto and to communicate therewith via the component interface 36.

The data processing module 40 is also configured to communicate with the controller 18 and to represent the components 16 or assemblies 14 with respect to the controller 18 as function-based representations 42.

The function-based representations 42 represent virtual abstractions of the individual components 16 or of entire assemblies 14 including a plurality of components 16.

This means that the hardware addresses and signals of individual sensors or actuators are no longer represented with respect to the controller 18, but rather data points or entities such as “start,” “stop,” “material available,” or similar.

The data processing module 40 can be configured to communicate sequentially or simultaneously with more than one of the components 16 and to represent the multiple components 16 with respect to the controller 18 as a single function-based representation 42.

In particular, the components 16 of an assembly 14, for example the sensors and actuators of a material feed or an industrial robot, can be abstracted into a single function-based representation 42 and represented with respect to the controller 18 by means thereof.

To achieve this, the gateway 34 in the described embodiment comprises an assignment table 44 which assigns at least one function-based representation 42 to each of the components 16 and/or assemblies 14 and/or comprises a plurality of function-based representations 42 and assigns at least one of the components 16 or assemblies 14 to each of the function-based representations 42.

The assignment table 44 thus creates a relationship between the components 16 or assemblies 14 on the one hand, in particular the hardware addresses thereof, and the function-based representations 42 on the other hand.

In simple terms, the gateway 34 thus forms a function interface 46 which can be accessed by the controller 18.

In the embodiment, the gateway 34 also comprises program code, in particular glue code 48, which maps a relationship between data of at least one of the components 16 and data of one of the function-based representations 42 so that the data can be transformed into each other. For example, the glue code 48 can be used to map a detected component state 16, such as a sensor signal, to an expected function-based representation 42 and represent it with respect to the controller.

Alternatively or additionally, it is also conceivable that a glue code 48 is used which maps a relationship between data of at least two of the components 16 so that the data of the respective components 16 can be converted into each other. For example, this allows sensors or actuators from different manufacturers which operate with different input and/or output signals to be easily exchanged with one another.

Furthermore, the gateway 34 comprises a hardware configurator 32, by means of which component configurations for configuring the individual components 16 can be set, in particular manually by a user.

The data processing module 40 can configure and/or parameterize components 16 connected to the component interface 36 by means of the hardware configurator 32.

The configuration and/or parameterization of the individual components 16 can therefore be carried out directly by the gateway 34. In simple terms, compared to conventional systems, the configuration and/or parameterization can be outsourced from the controller 18, thereby reducing the controlling complexity.

The data processing module 40 is further configured to always represent all components 16 and/or assemblies 14 which can be connected to the component interface 36 as function-based representations 42 with respect to the controller 18, regardless of whether the respective components 16 and/or assemblies 14 are actually connected to the component interface 36. The available function-based representations 42 are therefore always completely mapped with respect to the controller 18. In simple terms, there are thus always at least virtual endpoints which can be driven by the controller 18, regardless of whether the relevant components 16 and/or assemblies 14 are actually connected to the industrial plant 10 and/or are active. This enables particularly fault-tolerant driving.

The data processing module 40 is also configured to check whether one or more of the components 16 and/or assemblies 14 which is/are expected to be connected to the component interface 36 is/are actually connected to the component interface 36. This can be done in particular by means of a cyclic redundancy check. Since the available function-based representations 42 are always completely mapped with respect to the controller 18 and the latter does therefore not access the individual components 16 directly, the check of component completeness is, in simple terms, outsourced to the gateway 34. This measure also reduces the complexity and susceptibility to errors of the component or part driving in the fieldbus system 12 according to the present disclosure, compared to conventional systems.

The controller 18 of the fieldbus system 12 shown in FIG. 2 is configured to access the function-based representations 42 of the components 16 or assemblies 14 provided by the gateway 34 and to drive them on the basis of function-based control commands.

The function-based representations 42 correspond to virtual addresses of the individual components 16 and/or entire assemblies 14. A single component 16 or assembly 14 can therefore be addressed by the controller 18 on the basis of its respective function-based representation 42.

The gateway 34 then forwards the drivings by the controller 18 to the respective components 16. To this end, it uses the assignment table 44 and translates the function-based control commands, in simplified terms, into component-specific control commands, which in turn can be received and processed by the individual components 16.

In particular, function-based control commands which relate to an entire assembly 14 can also be divided by the gateway 34 into several individual component-specific control commands, for example to address the various actuators of a robot individually.

In the embodiment, the controller 18 further comprises a function configurator 50, through which individual function-based representations 42 can be configured. The function-based representations 42 can therefore be managed, in particular activated, deactivated or modified, by the controller 18.

Using the function configurator 50, for example when the industrial plant 10 is expanded by a new assembly 14, users can create a function-based representation 42 suitable for the new assembly 14, integrate it into the gateway 34, and/or activate it. This allows the operations management of the industrial plant 10 to be adapted to the changed hardware situation with little effort, in particular without having to configure individual components 16 of the new assembly 14 in the controller 18 in a complex manner.

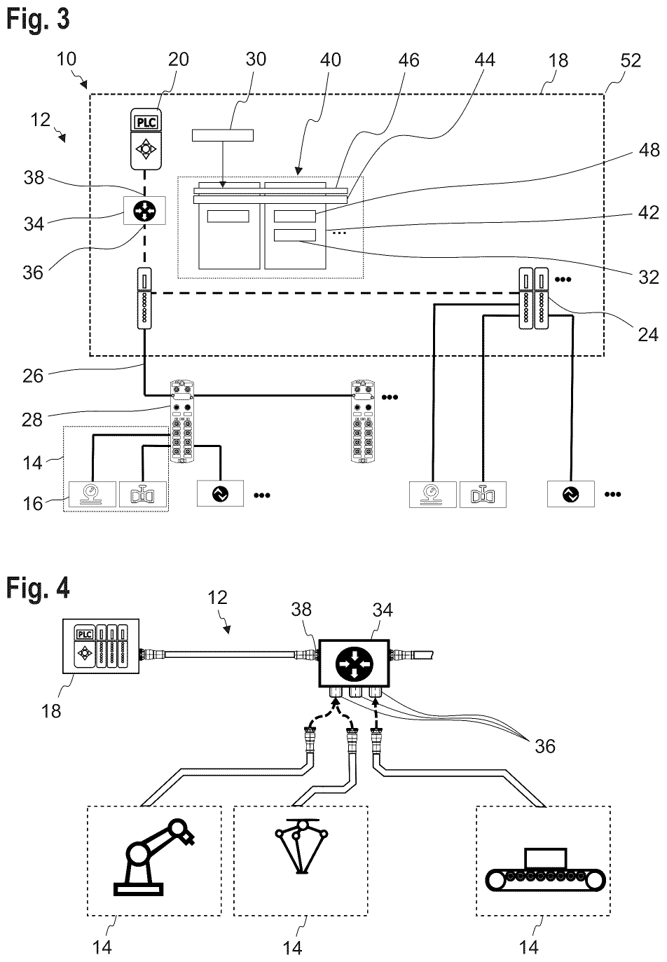

FIG. 3 shows a schematic representation of an industrial plant 10 and a fieldbus system 12 according to a second embodiment for controlling the industrial plant 10. The fieldbus system 12 in FIG. 3 substantially corresponds to that in FIG. 2, so that only the differences will be discussed below. Identical or functionally identical components are provided with the same reference numerals.

In contrast to the embodiment shown in FIG. 2, the fieldbus system 12 shown in FIG. 3 is not configured as a hardware device but as a software module that is implemented in a control device 52 comprising the controller 18.

FIG. 4 shows a schematic representation of a third embodiment of a fieldbus system 12 according to the present disclosure. It also corresponds substantially to the fieldbus systems 12 shown in FIGS. 2 and 3, so that only the differences will be discussed below. Identical or functionally identical components are provided with the same reference numerals.

The fieldbus system 12 shown in FIG. 4 has a gateway 34 which comprises a plurality of component interfaces 36 to which different assemblies 14 can be connected simultaneously or sequentially.

For example, one of the component interfaces 36 can be configured to be connected to different types of industrial robots, which can be represented with respect to the controller 18 using the same function-based representation 42. Assemblies 14 which are similar in their function and/or properties can thus be connected to the same component interface 36. No adjustments need to be made to the controller 18 itself for this purpose.

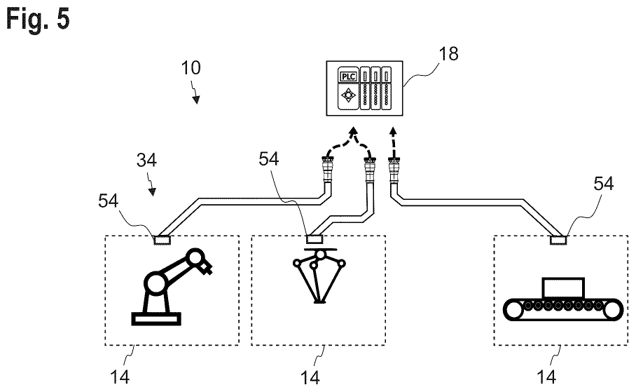

FIG. 5 shows a further embodiment of a gateway 34 according to the present disclosure. In this example, the gateway 34 is configured as a decentralized device comprising a plurality of gateway submodules 54. Each of the gateway submodules 54 is configured to be connected directly to a respective component 16 and/or assembly 14 of an industrial plant 10.

If, for example, a further component 16 or assembly 14 is to be connected to the industrial plant 10, it can simply be connected to a fieldbus end via a corresponding gateway submodule 54. For this purpose, the gateway submodules can for example be configured as adapters which can be connected directly to the respective component 16 or assembly 14, for example by means of a plug connection and/or screw connection.

The embodiments described are, of course, not to be understood in a restrictive way.

In particular, further embodiments of fieldbus systems 12 in which a plurality of gateways 34 is provided are conceivable.

The gateways 34 can be arranged in a cascade with respect with respect to the controller 18. This enables the components 16 to be driven with multiple abstraction levels. The controller 18 can therefore first issue a very abstract function-based control command, which is then increasingly specified by gateways 34 on its way to the component 16 to be driven.

List of Reference Numerals

| Reference | |
|---|---|
| numeral | Designation |
| 10 | Industrial plant |
| 12 | Fieldbus system |
| 14 | Assembly |
| 16 | Component |
| 18 | Controller |
| 20 | Arithmetic unit |
| 22 | Bus connection |
| 24 | Module |
| 26 | Fieldbus |
| 28 | Fieldbus module |
| 30 | Control program |
| 32 | Hardware configurator |
| 34 | Gateway |
| 36 | Component interface |
| 38 | Control interface |
| 40 | Data processing module |
| 42 | Function-based representation |
| 44 | Assignment table |
| 46 | Function interface |
| 48 | Glue Code |
| 50 | Function configurator |
| 52 | Control device |
| 54 | Submodule |

1. A gateway for a fieldbus system for connecting a controller to an industrial plant having a plurality of different components, comprising
at least one component interface via which the different components can be connected simultaneously or sequentially,
a control interface to which a controller of the industrial plant can be connected, and
a data processing module
which, when at least one of the components is connected to the at least one component interface, is configured to identify the at least one component on the basis of a hardware address assigned thereto and to communicate with the at least one component via the component interface, and
which, when the controller is connected to the control interface, is configured to communicate with the controller and to represent the at least one component with respect to the controller as a function-based representation.

2. The gateway according to claim 1, wherein the data processing module is configured to always represent all components which can be connected to the at least one component interface with respect to the controller as function-based representations.

3. The gateway according to claim 2, wherein the data processing module is configured to represent the components regardless of whether the respective components are actually connected to the component interface.

4. The gateway according to claim 1, configured as an independent hardware device for arrangement in the fieldbus system between the controller and at least one of the components.

5. The gateway according to claim 1, configured as a part of a hardware device of the industrial plant, the hardware device being a fieldbus module, a switch or an edge gateway.

6. The gateway according to claim 1, configured as a software module.

7. The gateway according to claim 6, wherein the software module is configured to be implemented in a control device comprising the controller.

8. The gateway according to claim 1, wherein the data processing module is configured to communicate sequentially or simultaneously with more than one of the components and to represent the plurality of components with respect to the controller as a single function-based representation.

9. The gateway according to claim 1, comprising an assignment table which assigns at least one function-based representation to each of the components and/or comprises a plurality of function-based representations.

10. The gateway according claim 1, comprising a program code that maps a relationship between first data of a first component of the components and second data of a function-based representation assigned to the first component, so that the first data and the second data can be converted into each other.

11. The gateway according to claim 10, wherein the program code is a glue code.

12. The gateway according to claim 1, comprising a hardware configurator by means of which component configurations for configuring the components can be set.

13. The gateway according to claim 12, wherein the configurations can be set manually by a user.

14. The gateway according to claim 1, wherein the data processing module is configured to configure and/or parameterize components connected to the component interface.

15. The gateway according to claim 1, wherein the data processing module is configured to check whether one or more of the components which are expected to be connected to the component interface are actually connected to the component interface.

16. The gateway according to claim 15, wherein the data processing module is configured to perform a cyclic redundancy check.

17. A fieldbus system for an industrial plant, comprising a gateway according to claim 1 and a controller connected to the gateway via the control interface.

18. The fieldbus system according to claim 17, wherein the controller is configured to access function-based representations provided by the gateway of components which can be connected to the industrial plant.

19. The fieldbus system according to claim 17, wherein the controller is configured to drive the function-based representations provided by the gateway, and wherein the gateway is configured to forward the drives from the controller to the components, taking an assignment table into account to which the gateway has access.

20. The fieldbus system according to claim 17, further comprising a function configurator by means of which individual function-based representations can be configured.
